(19) United States
(12) Patent Application Publication
(10) Pub. No.: US 2026/0102738 A1
(43) Pub. Date: Apr. 16, 2026

(54) PORTABLE AIR PURIFIER

(71) Applicant: Hanon Systems, Daejeon (KR)

(72) Inventors: Ji-Yong PARK, Daejeon (KR); Jae Ho KIM, Daejeon (KR)

(73) Assignee: Hanon Systems, Daejeon (KR)

(21) Appl. No.: 19/115,370

(22) PCT Filed: Jan. 10, 2024
(86) PCT No.: PCT/KR2024/000447

§ 371 Date: Mar. 26, 2025

(30) Foreign Application Priority Data
Feb. 20, 2023 (KR) 10-2023-0022348

(51) Int. Cl. B01D 53/88; B01D 53/00

(52) U.S. Cl. CPC B01D 53/885; B01D 53/007; B01D 2255/802; B01D 2258/06; B01D 2259/4558; B01D 2259/802

(57) ABSTRACT

The present invention relates to a photocatalytic portable air purifier that may maximize an air quality improvement effect by having a design structure optimized for a photocatalytic reaction and use a photocatalytic method to ensure convenient use and safety.

### TECHNICAL FIELD

The present invention relates to a portable air purifier, and more particularly, to a photocatalytic portable air purifier capable of maximizing an air quality improvement effect by having a design structure optimized for a photocatalytic reaction.

### BACKGROUND ART

Recently, there has been a growing concern about air pollution both indoors and outdoors. Therefore, there is an increasing demand for portable air purifiers to provide purified air to individuals or purify air in narrow spaces such as vehicle interiors.

Most portable air purifiers in the related art adopt a filtration method or an electric dust collection method. However, the filtration method causes an inconvenience of having to periodically replace a filter, and the electric dust collection method causes a problem in which nitrogen oxide or ozone harmful to a human body is produced.

Therefore, there is a need to develop a portable air purifier which is safe and convenient to use.

### DOCUMENT OF RELATED ART

### Patent Document

Korean Patent No. 10-2189493 (registered on December 4, 2020)

### DISCLOSURE

### Technical Problem

The present invention has been made in an effort to solve the above-mentioned problem, and an object of the present invention is to provide a photocatalytic portable air purifier that may maximize an air quality improvement effect by having a design structure optimized for a photocatalytic reaction and use a photocatalytic method to ensure convenient use and safety.

### Technical Solution

A portable air purifier according to an example of the present invention may include: a housing having a ventilation portion; and a purification module accommodated in the housing and configured to purify air introduced through the ventilation portion of the housing, in which the purification module includes: a light source configured to emit light; a photocatalytic member configured to perform a photocatalytic reaction by receiving the light emitted from the light source, and a fan configured to circulate the air between the outside and the inside of the housing, in which the light source emits visible light, and in which the photocatalytic member is configured to perform a photocatalytic reaction by receiving the visible light emitted from the light source.

A center column may be vertically disposed at a center of the housing based on a radial direction, the light source may be installed on the center column, and the photocatalytic member may be installed to surround the center column.

The light source may be configured as a light-emitting diode element.

The light-emitting diode element may be provided as a plurality of light-emitting diode elements disposed in a circumferential direction of the center column.

The light-emitting diode element may be provided as a plurality of light-emitting diode elements disposed in an axial direction of the center column.

The photocatalytic member may have a porous structure through which air passes.

An average pore size of pores formed in the photocatalytic member may be 1.0 mm or more and 4.0 mm or less, and a thickness of the photocatalytic member may be 3 mm or more and 10 mm or less.

The photocatalytic member may have a structure in which two or more unit photocatalytic members are stacked in the radial direction.

When among the stacked two or more unit photocatalytic members, any one unit photocatalytic member is referred to as a first unit photocatalytic member, and a unit photocatalytic member disposed radially outward of the first unit photocatalytic member is referred to as a second unit photocatalytic member, a porosity of the first unit photocatalytic member may be higher than a porosity of the second unit photocatalytic member.

The photocatalytic member may be provided as a plurality of photocatalytic members each having a long plate shape and disposed vertically.

The purification module may further include a holder disposed at a lower end side, and the photocatalytic member is inserted and fixed into the holder.

The center column may have a prismatic shape having a plurality of lateral surfaces, and the lateral surfaces of the center column may be configured to respectively face the photocatalytic members.

The fan may be disposed above the photocatalytic member.

The purification module may further include a main circuit board, and the main circuit board is disposed at a lower side of the housing.

The center column may be a circuit board having a lower end connected to the main circuit board.

### Advantageous Effects

According to the present invention, the air purifier has a design structure optimized for a photocatalytic reaction, thereby maximizing the air quality improvement effect, and the air purifier adopts, thereby ensuring convenient use and safety.

### DESCRIPTION OF DRAWINGS

FIG. 1 is a front perspective view of a portable air purifier according to an example of the present invention.

FIG. 2 is a rear perspective view of FIG. 1.

FIG. 3 is a side view of FIG. 1.

FIG. 4 is an exploded perspective view of FIG. 1.

FIG. 5 is a vertical cross-sectional view of FIG. 1.

FIG. 6 is a horizontal cross-sectional view of FIG. 1.

FIG. 7 is a view illustrating a photocatalytic member according to the example of the present invention.

FIG. 8 is a view illustrating an arrangement structure of light sources and the photocatalytic members according to the example of the present invention.

FIG. 9 is a view illustrating a center column separated from a configuration in FIG. 8.

FIG. 10 is a view illustrating a coupling relationship between vertical frames and the photocatalytic members.

FIG. 11 is a view illustrating a state in which the vertical frames are disassembled.

FIG. 12 is a cross-sectional view of the vertical frames.

FIG. 13 is a top plan view of FIG. 1.

### BEST MODE

Hereinafter, the present invention will be described with reference to the accompanying drawings.

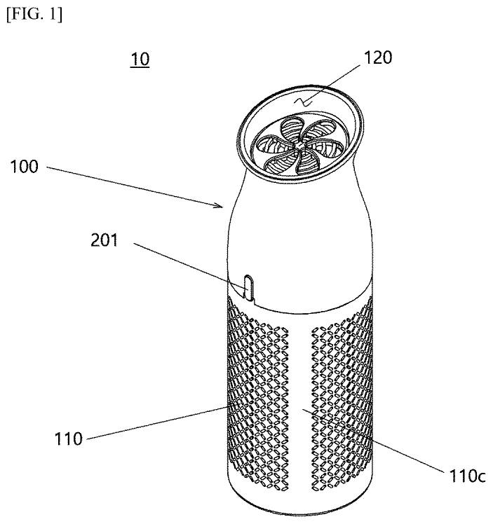

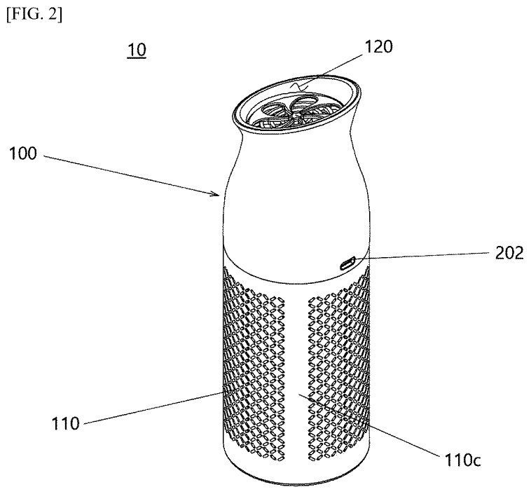

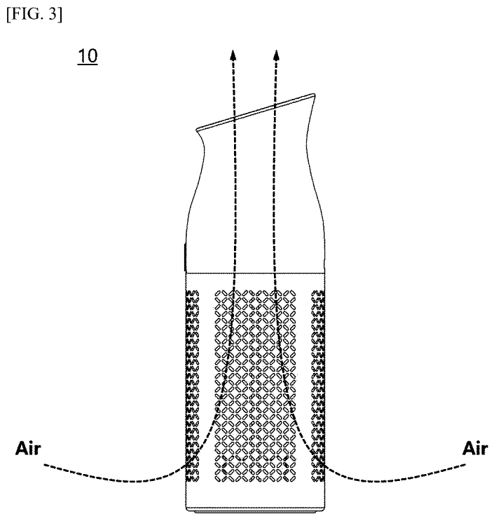

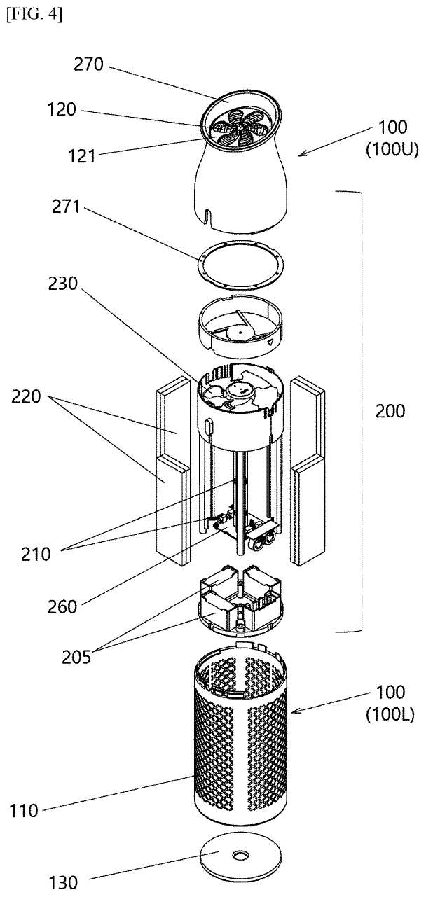

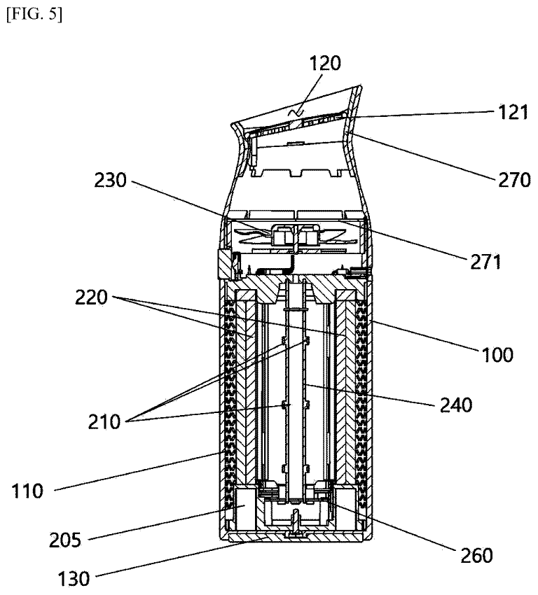

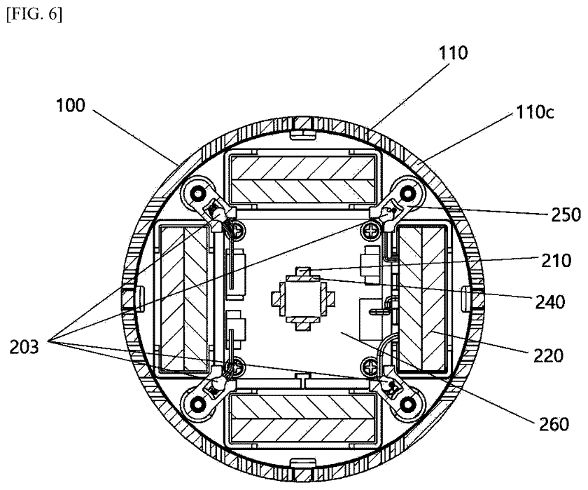

FIG. 1 is a front perspective view of a portable air purifier according to an example of the present invention, FIG. 2 is a rear perspective view of FIG. 1, FIG. 3 is a side view of FIG. 1, FIG. 4 is an exploded perspective view of FIG. 1, FIG. 5 is a vertical cross-sectional view of FIG. 1, and FIG. 6 is a horizontal cross-sectional view of FIG. 1.

Preferentially, as illustrated, a portable air purifier 10 of the present invention has an entirely long cylindrical structure and is configured to vertically stand on a ground surface or a floor surface. The portable air purifier 10 may be configured to be portable and used by being inserted into a cup holder in a vehicle. The portable air purifier 10 may be configured to have a diameter of about 70 mm so that the portable air purifier 10 may be universally inserted into the cup holder in the vehicle. In addition, a non-slip pad 130 may be provided on a bottom of the portable air purifier 10 to prevent a slip. For example, the non-slip pad 130 may be made of a PVC material with a high frictional coefficient.

With reference back to FIGS. 1 to 6, the portable air purifier 10 of the present invention broadly includes a housing 100 and a purification module 200.

The housing 100 is configured to accommodate the purification module 200 therein and has an entirely long cylindrical structure. The housing 100 has a ventilation portion 110 through which outside air may be introduced, and a discharge portion 120 through which the air introduced into the housing 100 may be discharged to the outside. For example, the ventilation portion 110 may have a plurality of ventilation holes and be formed on a lower side surface of the housing 100. The discharge portion 120 may be one open end of the cylindrical structure and has a structure opened upward from an upper end of the housing 100. Therefore, as illustrated in FIG. 3, air is introduced into a lateral lower region of the housing 100, and the introduced air may be discharged upward from the housing 100.

The purification module 200 is accommodated in the housing 100 and configured to purify the air introduced through the ventilation portion 110 of the housing 100. The purification module 200 may commonly include various types of components accommodated in the housing 100.

Specifically, the purification module 200 includes light sources 210 configured to emit light, photocatalytic members 220 configured to perform a photocatalytic reaction by receiving the light emitted from the light sources 210, and a fan 230 configured to circulate the air between the inside and the outside of the housing 100.

The fan 230 may be disposed at an upper side of the housing 100, more specifically disposed above the photocatalytic members 220. Therefore, as described above, air may be introduced into a lower lateral side of the housing 100 by an operation of the fan 230, and the air may be discharged upward from the housing 100.

In this case, in the present invention, the light source 210 is configured to emit visible light, and the photocatalytic member 220 is configured to perform the photocatalytic reaction by receiving the visible light emitted from the light source 210. Specifically, the light source 210 may emit visible light with a wavelength of about 400 to 700 nm, and the photocatalytic member 220 may be made of a material (e.g., a material including TiO₂, W_{O}_{₃}, Pt, and the like) that performs a photocatalytic reaction by receiving the visible light. Therefore, when the photocatalytic member 220 is irradiated with visible light, a photocatalytic reaction occurs on the surface of the photocatalytic member 220, and superoxide radicals are produced. The superoxide radicals, which are produced as described above, have high oxidation potential and oxidize harmful materials in the air to make the harmful materials harmless.

That is, the portable air purifier 10 of the present invention adopts the photocatalytic method other than a filtration method or an electric dust collection method in the related art, and the photocatalyst may be used semi-permanently without being separately replaced, such that the convenience of use and maintenance is ensured in comparison with the filtration method in the related art that needs to replace the filter. Because the superoxide radicals produced by the photocatalytic reaction react with harmful materials in the air and disappear immediately when the superoxide radicals are produced, the superoxide radicals are harmless to the human body. Therefore, the portable air purifier 10 may ensure stability in comparison with the electric dust collection method in the related art that produces nitrogen oxide or ozone harmful to the human body.

Further, the present invention is configured to be implemented by visible light using the photocatalytic method, such that the amount of use of energy may be reduced in comparison with a photocatalytic method using ultraviolet rays while requiring a large amount of energy. Further, unlike the method that requires a light-blocking film or the like installed to prevent ultraviolet rays from being introduced directly into the eyes, the visible rays are harmless to the human body, and a separate light-blocking film or the like does not need to be installed, such that the entire configuration may be simplified, and stability of use may be improved.

Hereinafter, the present invention will be described more specifically with reference to the specified embodiments.

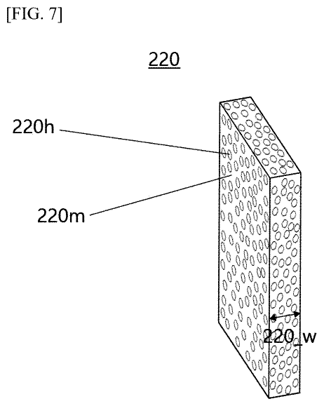

First, the photocatalytic member 220 will be described. FIG. 7 is a view illustrating the photocatalytic member according to the example of the present invention. As illustrated, the photocatalytic member 220 may have a porous structure in which pores are formed in an overall area, and all the pores are connected. More specifically, the photocatalytic member 220 may have a structure in which the porous structure is coated with a photocatalyst. The porous structure may be made of various materials such as metal, plastic, and paper. That is, the photocatalytic member 220 may have a structure in which a permeable means, through which air may pass, is coated with the photocatalyst.

In this case, the photocatalytic member 220 may be formed such that an average diameter of pores 220h formed in the photocatalytic member 220 is larger than an average width of a substrate 220m that constitutes the photocatalytic member 220. That is, in the overall volume of the photocatalytic member 220, a volume occupied by the pores may be larger than a volume occupied by the substrate. For example, a porosity of the photocatalytic member 220 may be 50% or more. At the same time or separately, an average pore size (i.e., a pore diameter) of the pores 220h of the photocatalytic member 220 may be 1.0 mm or more and 4.0 mm or less, and a thickness (220_w) of the photocatalytic member 220 may be 3 mm or more and 10 mm or less.

As described above, because the photocatalytic member 220 is made of a porous material with a high porosity, the flow resistance of the air passing through the photocatalytic member 220 may be reduced, and the air may easily circulate between the inside and the outside of the housing 100.

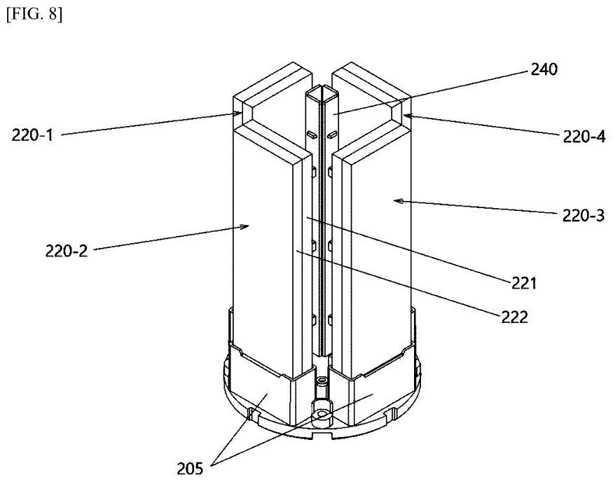

Further, for example, as illustrated in FIG. 8, the photocatalytic member 220 includes two or more unit photocatalytic members 221 and 222 and has a structure in which the corresponding unit photocatalytic members 221 and 222 are stacked in two or more layers in a radial direction. The corresponding unit photocatalytic members 221 and 222 may have different porosities. Specifically, among the unit photocatalytic members 221 and 222 stacked in two or more layers, the unit photocatalytic member 221 positioned relatively radially inward is referred to as a first unit photocatalytic member 221, and the unit photocatalytic member 222 positioned relatively radially outward is referred to as a second unit photocatalytic member 222. In this case, the porosity of the first unit photocatalytic member 221 may be higher than the porosity of the second unit photocatalytic member 222. At the same time or separately, an average pore size of the pores in the first unit photocatalytic member 221 may be larger than an average pore size of the pores formed in the second unit photocatalytic member 222.

With the above-mentioned configuration, a transmittance rate of the light passing through the first unit photocatalytic member 221 is increased, such that a larger amount of light may be introduced into the surface of the second unit photocatalytic member 222. Therefore, a surface reaction area between the photocatalytic member 220 and the light emitted from the light source 210 is entirely increased, such that air purification performance of the purification module 200 may be improved.

Next, because the air purification performance of the purification module 200 is proportional to the surface reaction area between the light source 210 and the photocatalytic member 220, it is advantageous to appropriately design and dispose the light source 210 and the photocatalytic member 220 to maximize the surface reaction area of the photocatalyst. To this end, in the present invention, the light sources 210 are installed at a center of the housing 100, and the photocatalytic members 220 are installed around the housing 100 to surround the light sources 210.

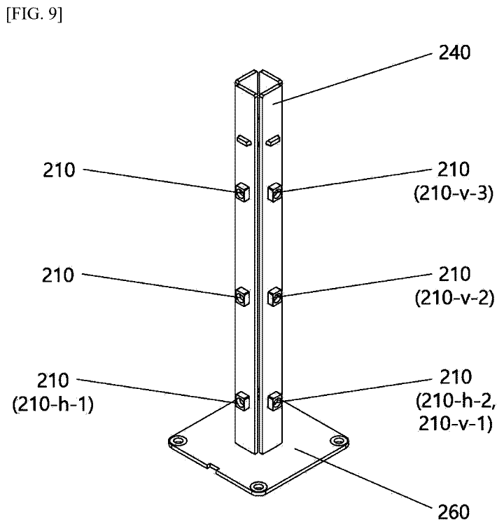

FIG. 8 is a view illustrating an arrangement structure of the light sources and the photocatalytic members according to the example of the present invention, and FIG. 9 is a view illustrating a center column separated from a configuration in FIG. 8. As illustrated, a center column 240 is vertically disposed at a center of the housing 100 based on the radial direction. The light sources 210 are installed on the center column 240, and the photocatalytic members 220 are installed to surround the center column 240. This structure may efficiently use the limited internal space of the housing 100 and ensure a maximally large surface reaction area of the photocatalyst, and the smooth fluidity of the air may also be ensured.

In this case, the light source 210 may be configured as a light-emitting diode element. The light-emitting diode element refers to a semiconductor element that emits light by means of electric currents. The light-emitting diode element requires lower power consumption and has a longer lifespan than a bulb or a lamp-type light source.

Because the light-emitting diode element is provided in the form of a kind of point light source, a plurality of light-emitting diode elements may be provided to cover the photocatalytic members 220 having large areas. Specifically, with reference to FIG. 9, the plurality of light-emitting diode elements (e.g., a first element 210-h-1 and a second element 210-h-2 in a horizontal direction in FIG. 9) may be provided and spaced apart from one another in a circumferential direction of the center column 240. At the same time or separately, the plurality of light-emitting diode elements (e.g., a first element 210-v-1, a second element 210-v-2, and a third element 210-v-3 in a vertical direction in FIG. 9) may be disposed to be spaced apart from one another in the axial direction of the center column 240. That is, the light source 210 has a structure in which a plurality of light-emitting diode elements are arranged in an array shape. Therefore, the light may be emitted omnidirectionally at 360 degrees based on the center column 240 and emitted omnidirectionally in the height direction, such that the entire surfaces of the photocatalytic members 220 disposed omnidirectionally may be irradiated with the light.

With reference back to FIGS. 4 and 9, the purification module 200 further includes a main circuit board 260. The main circuit board 260 refers to a circuit board for controlling power to the circuit components such as the fan 230 or the light source 210. The main circuit board 260 may be tightly attached to a lower portion of the housing 100, i.e., a bottom surface of the housing 100. Alternatively, the main circuit board 260 may be spaced apart from the bottom surface at a predetermined interval and disposed in the vicinity of the bottom surface. As described above, because the main circuit board 260 is disposed at the bottom side of the housing 100, a flow of air in the housing 100 is not hindered by the main circuit board 260.

With reference back to FIGS. 5, 6, and 9, the center column 240 may be configured as a circuit board having a lower end connected to the main circuit board 260. That is, the center column 240 itself may be configured as the circuit board. The center column 240 may control power to the light sources 210 installed on the center column 240 under the control of the main circuit board 260. This configuration assists in improving packaging properties and assemblability by excluding a separate wire for controlling the light source 210.

Meanwhile, a shape of the photocatalytic member 220 is not particularly limited as long as the photocatalytic members 220 are structured to surround the outer side of the center column 240. For example, although not illustrated, the photocatalytic members 220 define a cylindrical shape that surrounds the entire center column 240. In order to ensure assembling convenience, the photocatalytic member has a structure in which two separated parts are coupled to each other.

Alternatively, on the contrary, the plurality of photocatalytic members 220 may be arranged in an array shape. For example, as illustrated in FIG. 8, the photocatalytic members 220 may be provided as a plurality of photocatalytic members 220-1, 220-2, 220-3, and 220-4 each having an elongated plate shape. This configuration is advantageous in terms of the convenience in manufacturing the photocatalytic member.

In this case, the photocatalytic members 220-1, 220-2, 220-3, and 220-4 may be symmetrically installed with respect to the center column 240 to surround the center column 240. The photocatalytic members 220-1, 220-2, 220-3, and 220-4 may each be disposed perpendicularly to the bottom surface and disposed in parallel with the center column 240. Further, therefore, as illustrated in FIG. 9, the center column 240 is configured in a prismatic shape having a plurality of lateral surfaces. The lateral surfaces of the center column 240 may respectively face the photocatalytic members 220. FIGS. 8 and 9 illustrate a structure in which four photocatalytic members 220 are disposed to be spaced apart from one another, and the center columns 240 has four lateral surfaces, such that the lateral surfaces of the center column 240 respectively face the photocatalytic members 220-1, 220-2, 220-3, and 220-4.

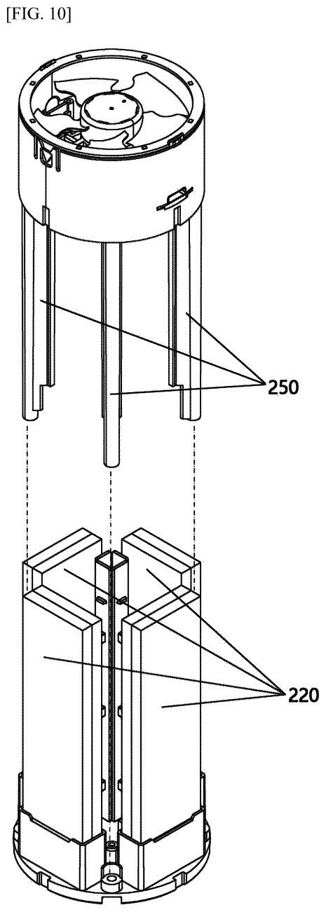

Further, as described above, based on the structure in which the plurality of photocatalytic members 220 are separately configured, the purification module 200 may further include vertical frames 250. FIG. 10 is a view illustrating a coupling relationship between the vertical frames and the photocatalytic members. As illustrated, the purification module 200 further includes the vertical frames 250 vertically disposed at the outer side of the purification module 200 based on the radial direction. The vertical frame 250 is disposed between the two adjacent photocatalytic members 220. That is, in the present example, four vertical frames 250 are configured, such that the four vertical frames 250 may be disposed between the four photocatalytic members 220 configured separately. The vertical frame 250 may block a gap between the two adjacent photocatalytic members 220 and prevent the air from being introduced into the gap, thereby improving the purification efficiency.

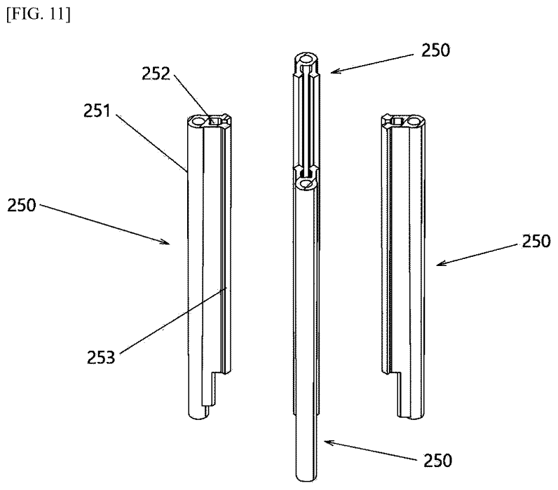

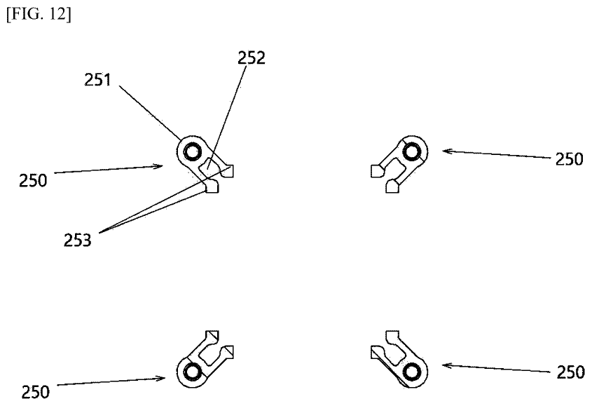

FIG. 11 is a view illustrating a state in which the vertical frames are disassembled, and FIG. 12 is a cross-sectional view of the vertical frames. As illustrated, an outer surface 251 of the vertical frame 250 directed toward the housing 100 is formed as a curved surface. This structure serves to divide the air, which is introduced into the outer surface 251 of the vertical frame 250, toward two opposite sides and guide the air to the photocatalytic members 220 disposed at the two opposite sides of the vertical frame 250. Therefore, this structure assists in purifying all the air introduced into the housing 100.

Further, therefore, the lateral surface of the housing 100 directed toward the vertical frame 250 may be closed. With reference back to FIGS. 1 and 2, as described above, the ventilation portion 110 having the plurality of ventilation holes is formed on the lower side surface of the housing 100. However, there is a closed portion 110c where the ventilation hole is not formed in a predetermined region in the circumferential direction. The vertical frame 250 may be disposed behind the closed portion 110c. This configuration may basically prevent the air from being introduced into the vertical frame 250, i.e., the gap between the two adjacent photocatalytic members 220 and further assist in concentratedly introducing the air into the photocatalytic members 220.

Meanwhile, with reference back to FIGS. 11 and 12, a hollow portion 252 may be formed in an axial direction in the vertical frame 250. As illustrated in FIG. 6, a wire 203 may be installed in the corresponding hollow portion 252. In order to facilitate the installation of the wire 203, one side of the hollow portion 252 may be opened. The wire 203 may be a wire for electrically connecting the main circuit board 260 and the fan 230. Because the main circuit board 260 is disposed at the lower side of the housing 100 and the fan 230 is disposed at the upper side of the housing 100 as described above, a wire is required to connect the main circuit board 260 and the fan 230. In the present invention, the hollow portion is formed in the vertical frame 250, and the wire 203 is disposed in the corresponding hollow portion, such that the wire may be concisely organized in the housing 100 and protected. In addition to the fan 230, the wire may connect a power button 201, a power terminal 202, and a lighting lamp 270 that will be described below. The types of wires 203 may be installed in the hollow portion 252 of the vertical frame 250.

Further, as illustrated in FIGS. 11 and 12, the vertical frame 250 may have flange portions 253 protruding outward, and the photocatalytic member 220 may be seated and supported on the flange portions 253 of the vertical frame 250. That is, the vertical frame 250 may have the flange portions 253 that are seating structures protruding to a predetermined degree from two opposite horizontal sides of the vertical frame 250 in the axial direction of the vertical frame 250. At least a part of an outer periphery of the photocatalytic member 220 may be tightly attached to and seated on the corresponding flange portions 253. This may assist in fastening and fixing the photocatalytic members 220 in the housing 100.

Further, as illustrated in FIG. 8, holders 205 may be disposed at a lower end side of the purification module 200, and lower end portions of the photocatalytic members 220 may be inserted and fixed into the corresponding holders 205. This may assist in more effectively fixing the photocatalytic members 220 in case that the photocatalytic member 220 has the structure in which the unit photocatalytic members 221 and 222 are stacked in two or more layers as described above.

With reference back to FIGS. 1 to 4, the housing 100 has an entirely elongated cylindrical shape and is configured to stand perpendicularly to the ground surface, i.e., configured such that the axial direction thereof is parallel to the gravitational direction. A housing 100 has a constant diameter from a lower end thereof to a predetermined height. This provides a structural advantage that allows the housing 100 to be inserted into the cup holder in the vehicle.

The housing 100 may have a structure in which a lower housing 100L and an upper housing 100U are coupled, this assists in assembling the purification module 200 in the housing 100. In this case, the above-mentioned ventilation portion 110 may be formed on the lateral surface of the lower housing 100L, the above-mentioned discharge portion 120 may be formed at an upper end of the upper housing 100U, and the lower housing 100L may have a constant diameter. The lower housing 100L may be longer than the upper housing 100U.

Further, a predetermined portion of the upper housing 100U set based on the height direction of the upper housing 100U may be formed to be narrow. That is, a diameter of the upper housing 100U decreases from a predetermined position in the height direction, and then the diameter of the upper housing 100U increases, such that a central portion thereof may be narrower than the other portions. Therefore, an outer cross-section of the upper housing 100U may be curved. As described above, the predetermined portion of the housing 100 is recessed and has a small diameter, such that a user may easily grip the portable air purifier 10 by using the corresponding portion. Further, a diameter of an airflow passageway increases, such that the purified air may be widely spread in the horizontal direction when the air is discharged to the outside from the inside of the housing 100. In addition, the recessed shape allows the portable air purifier 10 of the present invention to resemble a shape of a vase, thereby providing an aesthetic appearance satisfaction to the user. A diameter of the upper end of the upper housing 100U may be smaller than a diameter of a lower end of the lower housing 100L.

With reference back to FIGS. 1 to 4, the housing 100 has the power button 201 configured to operate the fan 230, and the power terminal 202 configured to receive power from the outside. In this case, the power button 201 and the power terminal 202 may be positioned above a center of the housing 100 based on the height direction. This allows the power button 201 and the power terminal 202 even though the bottom portion of the portable air purifier 10 is inserted into the cup holder in the vehicle, thereby providing the user with the convenience of manipulating the power button 201 and the connection convenience between the power terminal 202 and a power cable.

In this case, the power button 201 may be configured to operate or stop the fan 230 and adjust a rotation intensity of the fan 230. For example, when the power button 201 is pushed once in a state in which the fan 230 is stopped, the fan 230 may operate and rotate with a first intensity. In this state, when the power button 201 is pushed once more, the fan 230 may rotate with a second intensity. In this state, when the power button 201 is pushed once more, the fan 230 may rotate with a third intensity. In this state, when the power button 201 is pushed once more, the intensity of the fan 230 may return back to the first intensity, or the fan 230 may be stopped. At the same time or separately, in case that the power button 201 is pushed for a preset time, e.g., for 2 seconds or more, the operation of the fan 230 may be stopped. The first intensity, the second intensity, and the third intensity are different preset intensities, and the rotation intensity may increase as the number increases. The power button 201 may be configured to be operated in the form of a physical button or a touch button.

Further, the separate lighting lamp 270 may be used to indicate the current operating state and rotation intensity of the fan 230. With reference to FIGS. 4 and 5, the lighting lamp 270 configured to emit light is provided in the housing 100, and a lighting circuit board 271 configured to control the lighting lamp 270 may be further provided. For example, the lighting lamp 270 may be an LED lamp.

Further, the lighting lamp 270 may operate in conjunction with the operation of the power button 201 and emit light when the fan 230 operates. The lighting lamp 270 may be configured to emit light with colors different depending on the rotation intensities of the fan 230. For example, in case that the fan 230 rotates with the first intensity as the power button 201 is pushed once, the lighting lamp 270 may emit yellow light. In case that the fan 230 rotates with the second intensity as the power button 201 is pushed twice, the lighting lamp 270 may emit green light. In case that the fan 230 rotates with the third intensity as the power button 201 is pushed three times, the lighting lamp 270 may emit red light. In case that the fan 230 is stopped by manipulating the power button 201, the lighting lamp 270 may switch to an off state. This may visually indicate the current operating state of the fan 230 to the user, thereby providing the convenience of use and the aesthetic appearance satisfaction.

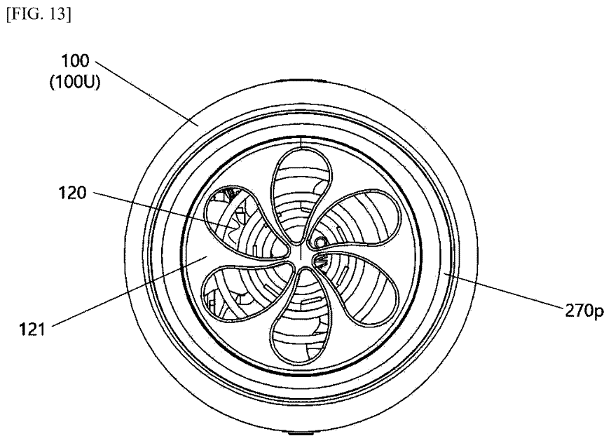

Further, a portion of the lighting lamp 270, which emits light, may be positioned at the upper end of the housing 100, such that the lighting lamp 270 may emit light upward from the housing 100. This may assist in improving the visibility of the light. FIG. 13 is a top plan view of FIG. 1. A portion 270p of the lighting lamp 270, which emits light, may be structured to be tightly attached to an inner peripheral surface of the upper end of the upper housing 100U and exposed upward.

Further, as illustrated in FIG. 13, a guard member 121 may be provided in the discharge portion 120 of the housing 100 and block a part of the discharge portion 120. The guard member 121 may prevent the user's hand or external items from being introduced into the housing 100 through the discharge portion 120. In this case, the guard member 121 may be provided in the form of petals and provide an aesthetic appearance so that the portable air purifier 10 of the present invention resembles a shape of a vase.

While the embodiments of the present invention have been described with reference to the accompanying drawings, those skilled in the art will understand that the present invention may be carried out in any other specific form without changing the technical spirit or an essential feature thereof. Therefore, it should be understood that the above-described embodiments are illustrative in all aspects and do not limit the present invention.

### DESCRIPTION OF REFERENCE NUMERALS

10: Portable air purifier, 100: Housing, 110: Ventilation portion
120: Discharge portion, 100U: Upper housing, 100L: Lower housing
200: Purification module, 210: Light source, 220: Photocatalytic member
230: Fan, 240: Center column, 250: Vertical frame
260: Main circuit board, 270: Lighting lamp

1. A portable air purifier comprising:
a housing having a ventilation portion; and
a purification module accommodated in the housing and configured to purify air introduced through the ventilation portion of the housing,
wherein the purification module comprises:
a light source configured to emit light;
a photocatalytic member configured to perform a photocatalytic reaction by receiving the light emitted from the light source, and a fan configured to circulate the air between the outside and the inside of the housing,
wherein the light source emits visible light and
wherein the photocatalytic member is configured to perform a photocatalytic reaction by receiving the visible light emitted from the light source.

2. The portable air purifier of claim 1, wherein a center column is vertically disposed at a center of the housing based on a radial direction,
wherein the light source is installed on the center column and
wherein the photocatalytic member is installed to surround the center column.

3. The portable air purifier of claim 2, wherein the light source is configured as a light-emitting diode element.

4. The portable air purifier of claim 3, wherein the light-emitting diode element is provided as a plurality of light-emitting diode elements disposed in a circumferential direction of the center column.

5. The portable air purifier of claim 3, wherein the light-emitting diode element is provided as a plurality of light-emitting diode elements disposed in an axial direction of the center column.

6. The portable air purifier of claim 2, wherein the photocatalytic member has a porous structure through which air passes.

7. The portable air purifier of claim 6, wherein an average pore size of pores formed in the photocatalytic member is 1.0 mm or more and 4.0 mm or less, and a thickness of the photocatalytic member is 3 mm or more and 10 mm or less.

8. The portable air purifier of claim 6, wherein the photocatalytic member has a structure in which two or more unit photocatalytic members are stacked in the radial direction.

9. The portable air purifier of claim 8, wherein when among the stacked two or more unit photocatalytic members, any one unit photocatalytic member is referred to as a first unit photocatalytic member, and a unit photocatalytic member disposed radially outward of the first unit photocatalytic member is referred to as a second unit photocatalytic member, a porosity of the first unit photocatalytic member is higher than a porosity of the second unit photocatalytic member.

10. The portable air purifier of claim 2, wherein the photocatalytic member is provided as a plurality of photocatalytic members each having a long plate shape and disposed vertically.

11. The portable air purifier of claim 10, wherein the purification module further comprises a holder disposed at a lower end side, and the photocatalytic member is inserted and fixed into the holder.

12. The portable air purifier of claim 10, wherein the center column has a prismatic shape having a plurality of lateral surfaces, and the lateral surfaces of the center column are configured to respectively face the photocatalytic members.

13. The portable air purifier of claim 2, wherein the fan is disposed above the photocatalytic member.

14. The portable air purifier of claim 2, wherein the purification module further comprises a main circuit board, and the main circuit board is disposed at a lower side of the housing.

15. The portable air purifier of claim 14, wherein the center column is a circuit board having a lower end connected to the main circuit board.
